(19) United States
(12) Patent Application Publication
(10) Pub. No.: US 2016/0058651 A1
(43) Pub. Date: Mar. 3, 2016

(54) DECORATIVE CUSHION MASSAGE DEVICE

(71) Applicant: Global Ideas Direct LLC, Reno, NV (US)

(72) Inventor: Scott Reid, Burr Ridge, IL (US)

(21) Appl. No.: 14/838,915

(22) Filed: Aug. 28, 2015

Related U.S. Application Data
(60) Provisional application No. 62/127,071, filed on Mar. 2, 2015.
(60) Provisional application No. 62/043,830, filed on Aug. 29, 2014.

(51) Int. Cl. A61H 7/00

(52) U.S. Cl. CPC A61H 7/007

(57) ABSTRACT

A decorative cushion for providing therapeutic shiatsu massage. The decorative cushion includes a cushion core comprising of a dual-foam structure. An electrically powered massage unit is placed off center in the bottom third of the cushion core. A first cushion cover covers the cushion core. A second cushion cover covers the cushion core when covered with the first cushion cover. The first cushion cover includes various forms of decoration or embroidery for aesthetic purpose.

### RELATED APPLICATIONS

This application claims priority to U.S. Patent Application Ser. No. 62/127,071 filed Mar. 2, 2015 and claims priority to U.S. Provisional Patent Application No. 62/043,830 filed Aug. 29, 2014, both of which are incorporated herein by reference in their entirety.

### BACKGROUND OF THE INVENTION

The invention relates generally to a decorative cushion that can provide massage, and other stimulation to various areas of the body.

Modern workers often suffer from fatigue of heads, necks, shoulders, cervical spines, etc. Some workers may even have cervical spondylosis and other forms of more serious diseases. In view of this problem, various massage devices have been developed to meet this problem.

However, to the casual observer, such devices appear visually to be pieces of equipment or medical instruments.

It is therefore an object of the present invention to provide a massage cushion that is visually decorative.

Another object is to provide a massage cushion that is easily controllable and without the look of a piece of equipment or medical instrument having gauges and control buttons.

It is yet another object to provide a massage cushion that can be easily cleaned.

It is yet another object to provide a massage cushion that provides comfortable use as a pillow support whether or not massage is being conducted by the cushion.

Massage devices can be divided into kneading type, percussion type, vibration type and rolling type. The embodiment described herein relates to the kneading type, referred to as Shiatsu massage.

### BRIEF SUMMARY OF THE INVENTION

A decorative cushion provides a massage, for example, in areas of neck, shoulders, and back. The massage device includes a cushion core with a dual-foam structure and a massage unit placed off center in the bottom third of the massage device providing a massage movement. The massage movement may be of several types, as for example, a kneading massage movement. A cushion cover receives the cushion core, and in certain embodiments, the cushion cover includes fanciful decoration, embroidery and shapes for aesthetical purposes. The cushion cover provides a fabric icon for use as part of an ON/OFF switch connected with the massage unit so that a user can easily turn ON or turn OFF the massage device. The massage device may include an electrical wire/plug to be plugged into a conventional electrical outlet.

Alternatively, certain embodiments of the present invention may have self-powered electrical sources, such as a battery, positioned within the massage unit outside of the view of the user and others. These self-powered electrical sources can be easily recharged for repeated use.

The massage unit is positioned off center within the cushion so as to provide certain advantages. Such a position can provide a full-range massage to a user's neck, as well as to the lower cervical spine area. If a user wants to massage his or her shoulders or upper back, the massage device may be rotated so as to provide massage to those areas.

### BRIEF DESCRIPTION OF SEVERAL VIEWS OF THE DRAWINGS

FIG. 1 illustrates a perspective view of a massage cushion according to the present invention.

FIG. 2A illustrates a side view of an inner core of the massage cushion of FIG. 1.

FIG. 2B illustrates a top view of the inner core of FIG. 2A.

FIGS. 2C, 2D, 2E, 2F, 2G, and 2H illustrate a massage compartment or pouch and a massage unit which is placed in the compartment, and together both are placed into the inner core of the massage cushion of FIG. 1.

FIG. 3A illustrates a side view of the inner core of FIG. 2A which is partially covered with an inner cover.

FIG. 3B illustrates a top view of the inner cover of FIG. 3A which fully covers the inner core of FIG. 2A.

FIG. 4A illustrates a side view of the inner core of FIG. 2A, together with the inner cover of FIG. 3B in a closed position, which is partially covered with an outer cover.

FIG. 4B illustrates a side view of the massage cushion of FIG. 1.

FIG. 4C illustrates a holding band 44 sewn in the outer cover of the massage cushion of FIG. 1.

FIG. 5 illustrates a partial top view of the outer cover of FIG. 4A and more particularly, the lower left corner of the backside of the outer cover.

FIG. 6 illustrates a partial top view of the outer cover of FIG. 5, folded upon itself to reveal the lower left corner of the inner cover of FIG. 2A.

FIG. 7 illustrates the inner cover of FIG. 3B, folded upon itself to reveal the corner of the inner core of FIG. 2A.

FIG. 8 illustrates the outer cover of FIG. 5 shown empty and in a flat position.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE PREFERRED EMBODIMENTS

Preferred embodiments of the invention will now be described with reference to the accompanying drawings, in which several embodiments are shown. Embodiments may, however, be embodied in many different forms and should not be construed as limited to the embodiments set forth herein. Rather, these embodiments are examples of the invention, which has the full scope indicated by the language of the claims. Like reference numbers refer to like elements throughout.

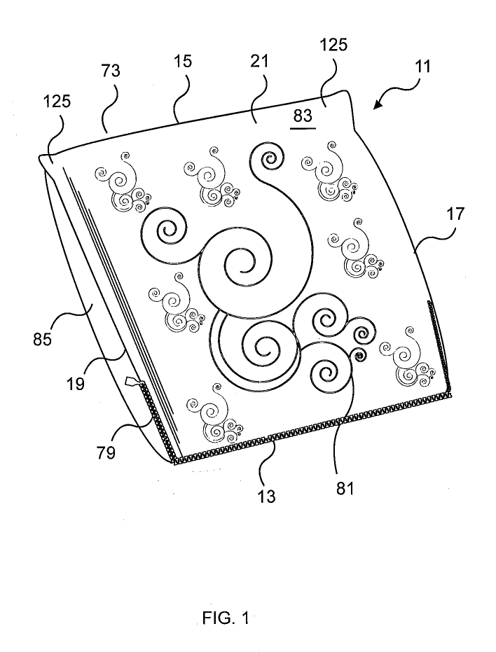

Referring to FIG. 1, a massage cushion 11 is constructed generally rectangular in shape having a bottom edge 13, a top edge 15, a right side edge 17 and a left side edge 19. A massage unit (not shown) is housed within massage cushion 11 and provides a kneading type massage movement, referred to as a Shiatsu massage movement. The massage movement occurs at the back side 85 of the cushion and against which the user places his or her neck and shoulders, for example.

As an example, massage cushion 11 may be 18 inches long, 18 inches wide and 7 inches deep. Other configurations and dimensions may be used.

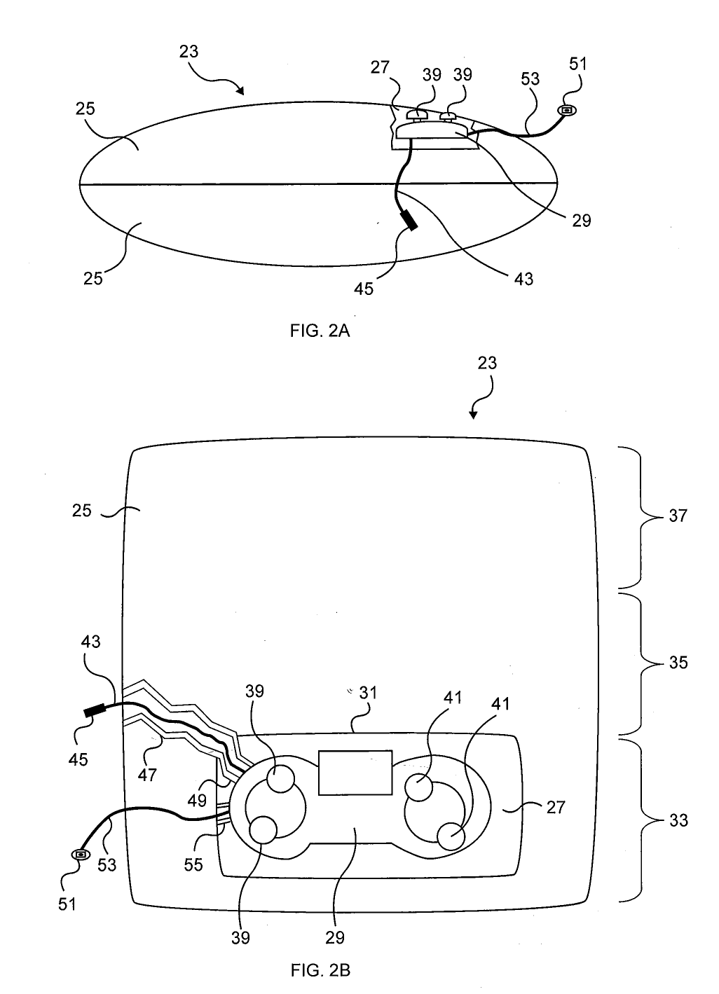

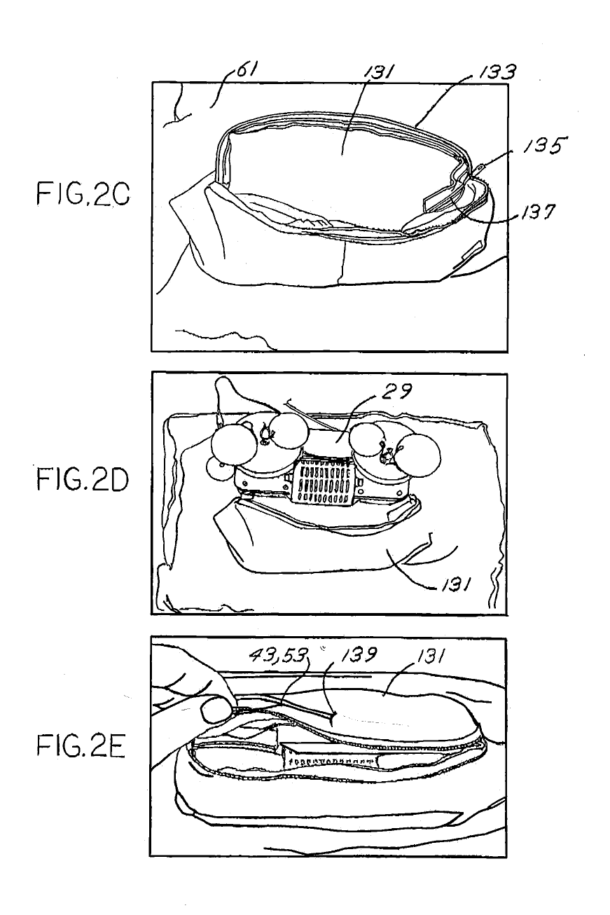

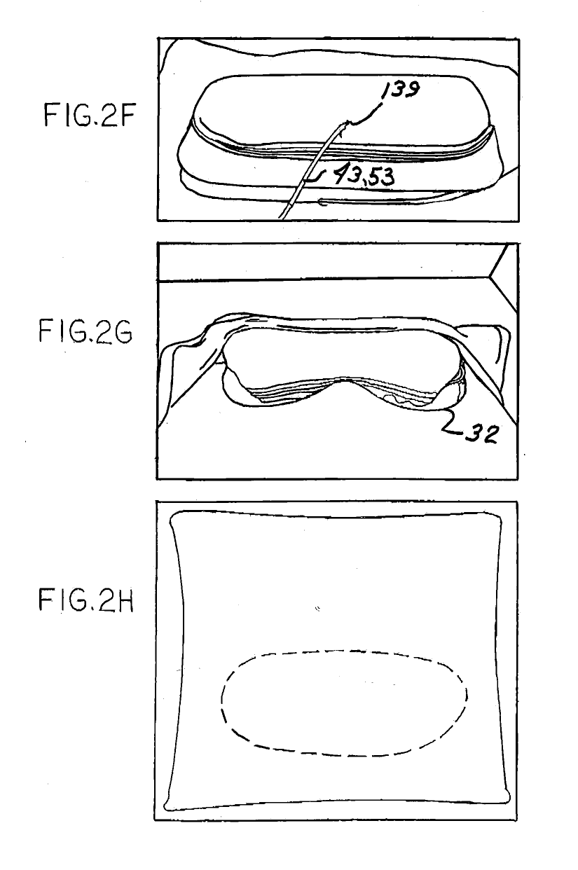

Referring to FIGS. 2A and 2B, an inner core 23 is the primary component of cushion 11. Inner core 23 includes a first core section 25 having an outer dimension to dictate the shape of cushion 11, and has a second core section 27 to hold a massage unit 29 into a fixed position relative to inner core 23.

First core section 25 is made as a single unitary piece of a first compressible foam material. The foam material measures a hardness of between 20-30 degrees using a Durometer scale. For example, the foam material is polyurethane. First core section 25 has a consistent level of compressibility throughout its shape and has a firmness of 38 IFD. The degree of compressibility provides comfort to the user, as well as a soft pillow-like support and feel to the cushion.

Second core section 27 (FIG. 2B) is made as a single unitary piece of a second compressible foam material, which also is made from polyurethane, e.g., 38 LX-C(Normal Urethane). Second core section 27 is located in an aperture 31 (FIG. 2B) formed in the lower one-third portion 33 of the three one-third portions 33, 35, 37 of first core section 25. Aperture 31 is positioned in the lower one-third portion 33 of inner core 23. Aperture 31 is of a size to receive second core section 27 so that it fits snugly within first core section 25. First core section 25 may be compressed to expand aperture 31 somewhat in order to receive second core section 27 in a tight fixed fashion.

Massage unit 29 may be secured to second core section 27 by polyurethane glue or any other suitable means. The compressible material of second core section 27 is more firm in compressibility than the compressible material of first core section 25, such that massage unit 29 is held fixed relative to the second core section 27. Second core section 27 is shaped so as to receive massage unit 29 and so as to allow its kneading components to rotate freely. In addition, second core section 27 aids in positioning unit 29 so as to provide massage action to back side 85 of the cushion.

Massage unit 29 may be, for example, a kneading massage unit of the type illustrated and described in U.S. Patent Publication No. 2012/0010544. Massage unit 29 may include two massage ball bodies 39 and two massage ball bodies 41 (referred to herein as Shiatsu balls). Massage ball bodies 39, 41 are driven to rotate and so to be used to knead and massage a human body. Massage ball bodies 39, 41 are rotated in reverse directions to one another (e.g., clockwise for bodies 39 and counterclockwise for bodies 41). Further, a timer (not shown) may be used to automatically switch the directions of rotation of the massage ball bodies after a predetermined time period. For example, after sixty seconds, bodies 39 may switch to rotate counterclockwise and bodies 41 may switch to rotate clockwise; then after another sixty seconds, bodies 39 may switch back to rotate clockwise and bodies 41 may switch back to rotate counterclockwise. Such a switching of rotational direction provides a pleasant effect to the user. The timer may include a program stored on an electronic chip which is accessed by a controller for driving bodies 39, 41. In addition, a thermal effect on the user may be generated by a heating element (not shown) which thermoelectrically heats massage ball bodies 39, 41. The two massage ball bodies 39 may be configured to different outer surface sizes (volumes). Likewise, the two massage ball bodies 41 may be configured to different outer surface sizes. The user may thus feel the gradational strength of the massage ball bodies. Other conventional types of massage devices may be used in the massage unit 29, as will suggest itself.

Massage unit 29 includes a disconnectable power supply cord 43 which connects massage unit 29 to a source of electricity for powering the unit. Power supply cord 43 extends outwardly from massage unit 29 and is of a length to extend outside of the perimeter area of cushion 11. Cord 43 terminates in an electrical connector 45 which is mateable with another electrical connector (not shown) of a second power cord (also not shown). Power may be supplied directly from the second power cord to massage unit 29 via cord 43. As will suggest itself, alternatively, electrical connector 45 may be a conventional wall plug that may be plugged into a conventional electrical wall outlet.

A pair of passageways 47, 49 may be formed or cut into respectively first core section 25 and second core section 27 of the compressible foam material. Passageways 47, 49 provide a trough or channel to receive power supply cord 43, and thus keep cord 43 away from the outer top surface of core sections 25, 27.

Alternatively, a battery (not shown) may be used to power massage unit 29 instead of electricity through cord 43. Thus, cord 43 can be avoided. Alternatively, cord 43 may be used with a rechargeable battery to supply electricity for recharging of the battery. After the battery is charged, cord 43 may be removed.

Massage unit 29 also includes a ON/OFF switch 51 and an associated connection cord 53. Cord 53 extends outwardly from massage unit 29 allowing ON/OFF switch 51 to be positioned at a convenient place for user actuation. ON/OFF switch 51 operates to turn massage unit 29 ON or OFF, as described more fully herein. A passageway 55 may be formed or cut into the compressible foam material of second core section 27 to provide a channel to receive cord 53, and thus keep cord 53 away from the outer top surface of core section 27.

Referring to FIG. 2C, a massage unit compartment or pouch 131 is provided in another embodiment. Pouch 131 is shaped and is of a size to receive and contain massage unit 29. The massage unit 29 may fit snugly within the massage unit pouch 131, such that, for example, no adhesive is required to hold the massage unit 29 in place within pouch 131.

Pouch 131 may be constructed as a separate unit. In addition, pouch 131 may be sewn into a position on an inner cover 61 (described hereinafter) which receives the inner core 23. Alternatively, pouch 131 may be constructed to include a portion 132 of inner cover 61, and so firmly locate pouch 131 relative to inner core 23.

Pouch 131 is openable along at least a portion of one of its sides by a zipper closure mechanism 133 having a zipper head 135 and a pair of zipper tracks 137. Pouch 131 may be formed of cloth mesh material, for example, 100% polyester, and may be of a solid beige color. Such a cloth mesh material may be made from nylon material, for example. Such a cloth mesh material may assist with dissipating heat generated from the massage unit 29. The massage unit pouch 131 provides additional support to hold the massage unit 29 in place relative to the inner core.

Referring to FIGS. 2D-2G, massage unit 29 is placed within massage unit pouch 131 (FIGS. 2D, 2E) and then pouch 131 is zipped closed retaining unit 29 within pouch 131 (FIGS. 2E, 2F). As shown in FIG. 2F, power cord 43 and connection cord 53 protrude from a hole 139 formed in pouch 131. Finally, as shown in FIG. 2G, pouch 131 containing unit 29 is placed into an aperture or cavity 32 formed in first core section 25. Cavity 32 may have a shape, as shown, similar to the shape of unit 29. Thus, second core section 27 may not be used. Alternatively, aperture 32 may be formed in second core section 27 (FIG. 2). Core section 27 may provide expansion to aperture 32 allowing it to act as a sponge cavity so that pouch 131 fits snugly within cavity 32. The walls of cavity 32 hold pouch 131 containing massage unit 29 in place without need for glue or other adhesive. The mesh pouch provides additional support to hold the massage unit in place and prevents the massage unit from falling out of position while resting in cavity 32.

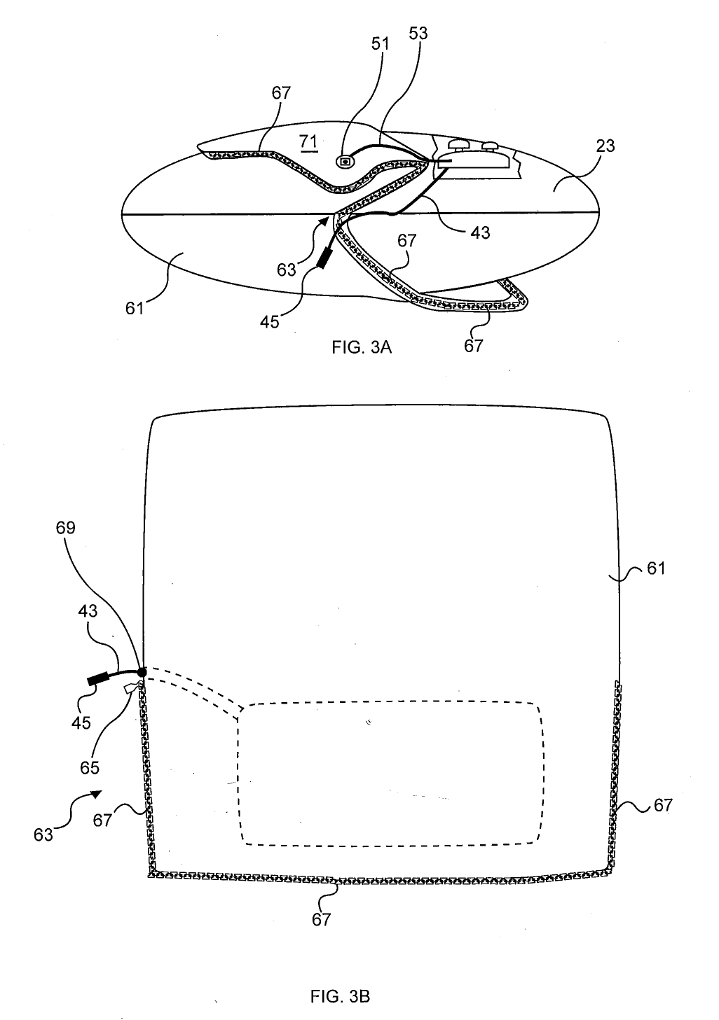

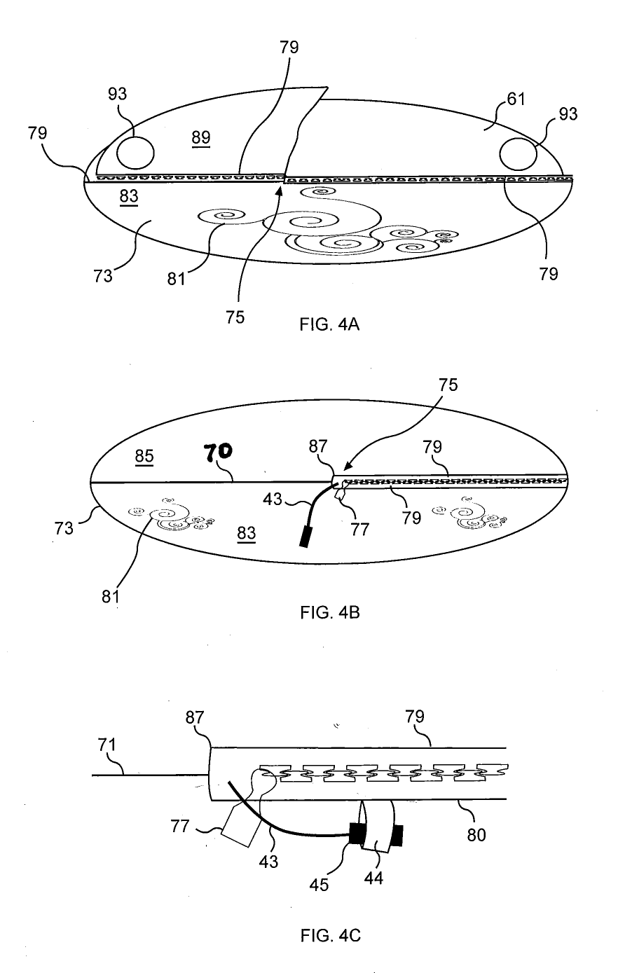

Referring to FIGS. 3A and 3B, and FIG. 2H, inner core 23 is insertable within, and received by inner cover 61. Inner cover 61 has the shape of cushion 11 and is openable along three of its sides by a zipper closure mechanism 63 comprised of a zipper head 65 and a pair of zipper tracks 67. Zipper tracks 67 extend along the lower portions of the two sides of inner cover 61 and along the bottom side of inner cover 61, as shown in FIG. 3B. Zipper tracks 67 may instead be placed at the upper portions of the two sides of the inner cover 61 and along the top side of inner cover 61. Thus, locating the zipper tracks 67 at the upper portion of the inner cover 61 may prevent any interference between zipper tracks 67 and zipper tracks 79 (FIG. 4B) of an outer cover 73, described below. Inner cover 61 is shown open in FIG. 3A and shown closed in FIG. 3B. Inner cover 61 may be formed of cloth material, for example, 100% polyester and may have a solid beige color. Such a cloth material may be made from nylon material, for example.

When zipper closure mechanism 63 is open fully (as shown in FIG. 3A), inner core 23 may be inserted within inner cover 61. Once inner core 23 is received into inner cover 61, inner cover 61 may be closed by zipper closure mechanism 63 (as shown in FIG. 3B). Power supply cord 43 is positioned so as to extend out through the zipper opening at a location 69 where zipper tracks 67 end. Thus, zipper head 65 will end its movement to close the inner cover immediately adjacent to cord 43 at location 69. Should tracks 67 be located at the upper portion of inner cover 61, zipper head 65 will likewise end its movement to close the inner cover at location 69. ON/OFF switch 51 is secured to the underside surface 71 (as shown in FIG. 3A) of inner cover 61, as more fully described hereinafter.

As shown in FIG. 3B, zipper head 65 includes a small pull handle. However, inner cover 61 may be constructed to prevent or discourage removal of inner cover 61 from inner core 23. For example, zipper head 65 may be turned over so as to travel with respect to the inside of the cover and the pull handle may be removed from the zipper head. The inner cover thus protects the inner components of the cushion as well as protects the user from easily gaining access to the inner components. The inner core also protects an outer cover 73, described hereinafter, from wear and tear (friction) from massage unit 29.

Referring to FIGS. 4A and 4B, inner core 23 (not shown) when covered with inner cover 61 (FIG. 4A) is inserted within and received by outer cover 73. Outer cover 73 has the shape of the cushion 11 and is openable along three of its sides by a zipper closure mechanism 75 comprised of a zipper head 77 and a pair of zipper tracks 79. Zipper tracks 79 extend along the lower portions of the sides of outer cover 73 and along the bottom of outer cover 73. Outer cover 73 is shown open in FIG. 4A and shown closed in FIG. 4B. Outer cover 73 may be formed of cloth material, e.g., cotton, and carries a decorative pattern 81 on its front side 83 and is only colored white on its back side 85. Such cloth material would be fabric used on conventional decorative pillows found on high quality living room furniture.

Zipper closure mechanism 75 runs along part of the right side edge 17 (FIG. 1), the bottom edge 13 (FIG. 1) and part of the left side edge 19 (FIG. 1). When the zipper closure mechanism 75 of outer cover 73 is open fully (as shown in FIG. 4A), the inner core 23 (which is covered with inner cover 61) may be inserted within outer cover 73. Once inner core 23 (covered with inner cover 61) is inserted, outer cover 73 may be closed by the zipper closure mechanism 75. Power supply cord 43 is positioned so as to extend out through the zipper opening at a position 87 (FIG. 4B) where zipper tracks 79 end. As shown in FIG. 4C, an elastic band 44 may be sewn adjacent to zipper opening and adjacent to position 87 in order to hold electrical connector 45 (with its extended portion of power supply cord 43) and contain electrical connector 45 from dangling or flopping. Band 44 is rectangular in shape folded and having its two ends sewn to the zipper cover interface 80. ON/OFF switch 73 (not shown in FIG. 4A) is secured relative to the underside surface 89 of outer cover 73, as described hereinafter.

As shown in FIG. 1, decorative pattern 81 may be printed, embroidered, sewn or otherwise secured to front side 83 of outer cover 73. Decorative pattern 81 may be a fancy, high quality design found on conventional decorative cushions. Back side 85 of cushion 11 is without decoration and is only a solid color. Front side 83 and back side 85 may be of one piece of material, or alternatively be connected together along their four sides 13, 15, 17 and 19 by a seam or stitching 70 (FIG. 4B) and by zipper tracks 79. Zipper tracks 79 are disposed along the bottom edge 13 and partially along each of side edges 17, 19 of cushion 11, similar to the inner cover zipper closure mechanism 63 shown in FIG. 3B.

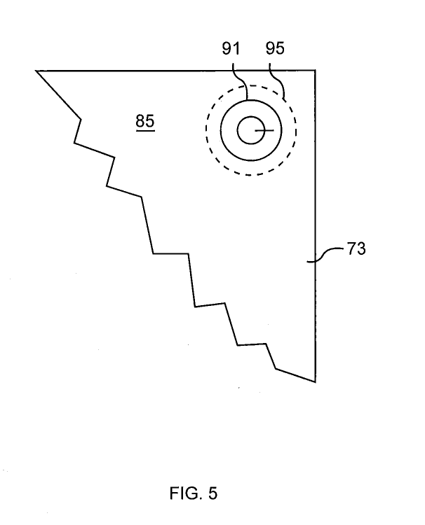

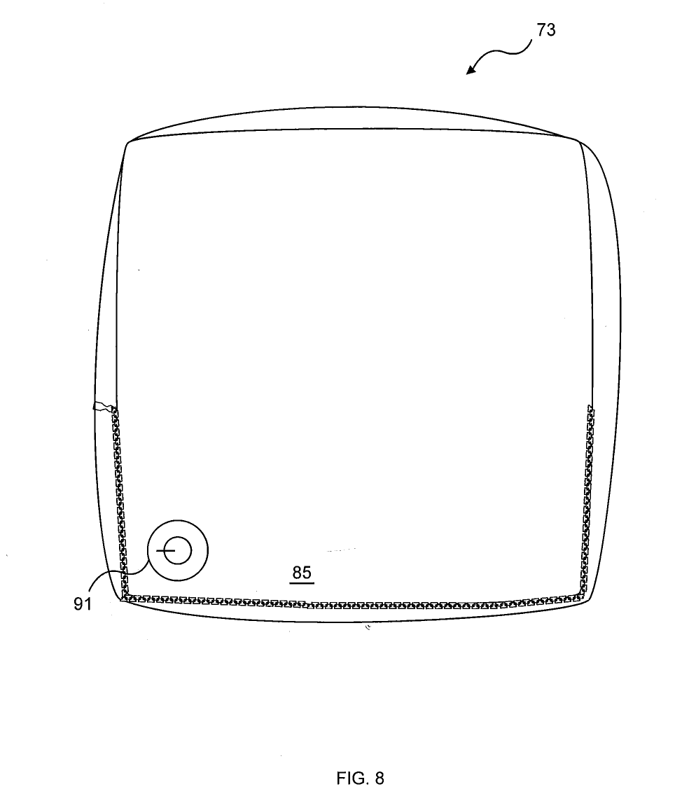

Referring to FIG. 8, the backside 85 of outer cover 73 includes a decorative icon 91. As shown in FIG. 5, icon 91 has a circle shape, and may be formed of a separate piece of material sewn to the back side 85. Alternatively, icon 91 may be a shape that is directly stitched or embroidered onto outer cover 73. It is shown somewhat enlarged in FIG. 8, but may have a diameter slightly larger than that of a hand thumb.

Icon 91 is located in the lower left corner of outer cover 73 (FIG. 8) as viewed from the back side. The user presses firmly against icon 91 with his or her thumb in order to activate ON/OFF switch 51 (FIG. 2A). This action of pressing against icon 91 closes switch 51, and thus turns ON the massage unit, or else the action deactivates ON/OFF switch 51 by opening switch 51 and thus turns OFF the massage unit. When massage unit 29 is ON, pressing icon 91 causes the massage unit to turn OFF. When massage unit 29 is OFF, pressing icon 91 causes the massage unit to turn ON.

In addition, heat may be applied from inside the massage cushion by a heater (not shown), e.g., a metal heating wire or blade, which receives electrical power via power supply cord 43. The heater may turn ON when the massage unit is activated by the pressing of icon 91.

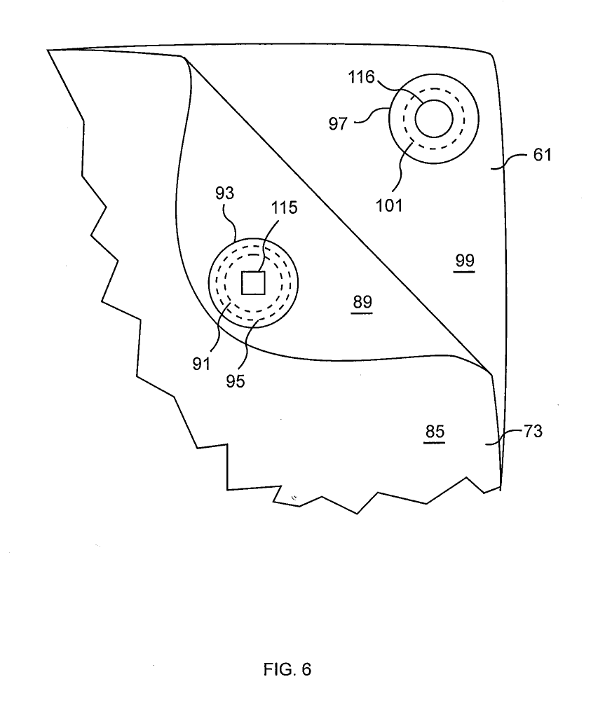

Referring to FIG. 6, outer cover 73 is shown pulled back onto itself to reveal underside surface 89 of outer cover 73. Secured onto underside surface 89 is an attachment ring 93. Attachment ring 93 is positioned directly beneath icon 91 (which is located on the backside 85 of outer cover 73). Attachment ring 93 is formed as one component of a Velcro attachment device (having hooks-and-loop material). That is, attachment ring 93 is formed from either one of the two Velcro components: typically two plastic sheets, one sheet covered with tiny loops and the other sheet covered with tiny flexible hooks, which two components adhere together when the components are pressed together. Ring 93 is circular in shape and is sewn to the underside surface 89 via thread stitches 95 which trace a circular pattern. Stitches 95 in a circular pattern are also shown on the backside 85, in FIG. 5, surrounding icon 91.

As shown in FIG. 6, another attachment ring 97 is secured to top surface 99 of inner cover 61. Attachment ring 97 is formed as a Velcro hooks-and-loop material component, the opposite to component of ring 93 so as to adheringly mate with ring 93. Ring 97 is circular in shape and of the same size as ring 93, and is sewn to inner cover 61 by stitches 101. Attachment ring 97 is located at a position on inner cover 61 so as to align with attachment ring 93 when the outer cover 73 is closed over inner cover 61. The two attachment rings 95, 97 mate together and attached to one another via the Velcro structure so as to maintain icon 91 securely positioned relative to inner cover 61, i.e., relative to the position of sewn-on ring 97.

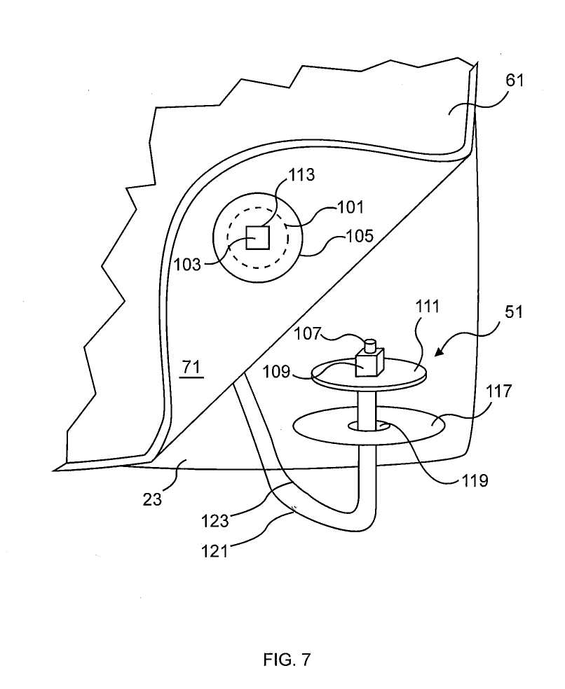

Referring to FIG. 7, inner cover 61 is shown pulled back onto itself to reveal the underside surface 71 of inner cover 61. Secured onto underside surface 71 and vertically beneath the attachment ring 97 (FIG. 6) is another attachment ring 105. Attachment ring 105 is formed as a Velcro hooks-and-loop material component. Ring 105 is sewn to underside surface 71 of inner cover 61 via thread stitches 101 which trace a circular pattern. Thread stitches 101 in its circular pattern are also shown sewn on the ring 97 in FIG. 6, as well. Stitches 101 secure both attachment rings 97, 105 to inner cover 61.

As shown in FIG. 7, ON/OFF switch 51 includes and ON/OFF button 107 mounted to a button support structure 109 (which contains a conventional electrical switch) and a circular base 111. Switch 51 is positioned against underside surface 71 of inner cover 61 and into a square shaped area generally designated by reference numeral 103. Area 103 is defined by a square aperture 113 being formed in attachment ring 105. Square shaped aperture 113 conforms to the square shaped top surface of button support structure 109 allowing the button support structure 109 to seat within square shaped aperture 113.

Referring again to FIG. 6, a square shaped aperture 115 (FIG. 6) may be fondled in attachment ring 93 to allow the button support structure 109 to seat also within square shaped aperture area 115. Such a positioning aligns ON/OFF button 107 with decorative icon 91 (FIG. 5). The aperture 116 of ring 97 may be circular, or other shape, of a size sufficient to allow button support structure 109 to seat into aperture 115.

Referring again to FIG. 7, an attachment ring 117 is made of a Velcro hooks-and-loop material and includes a central aperture 119 which is of a size to receive electrical wires 121, 123 from the ON/OFF switch 51. Ring 117 is of a size for mating with attachment ring 105 to hold and secure ON/OFF switch 51 in position against square shaped area 103. Circular base 111 of switch 51 is of a diameter larger than central aperture 119 so that attachment ring 117 holds switch 51 firmly in place and against area 103. Wires 121, 123 form cord 53 (FIGS. 2A, 2B) and feed into inner core 23 and connect to massage unit 29.

Referring again to FIG. 1, in addition to decorative pattern 81 on the front side 83 of outer cover 73, outer cover 73 may also include pointy ears 125, as shown in FIG. 1, at each of the upper corners of cushion 11. Because the zipper opening of outer cover 73 is located at the bottom of cushion 11, the fabric material at the top of outer cover 73 may be configured in a fashionable structure, e.g., to provide pointy ears 125. In addition, extra fabric material may be allotted to outer cover 73 in the area adjacent to the massage unit so as to allow outer cover 73 to easily slip over the covered massage unit and thereafter be easily zipped closed. Further, stitched designs may mold the front side of the outer cover in fanciful shapes, as for example, a central diamond shape or other shape centrally located on the cushion. Further, inner core 51 may be molded to a particular shape that is visually evident from viewing of outer cover 73; the outer cover may be held tight against the inner core so as to provide a similar shape or an affected shape, to outer cover 73.

Cushion 11 has a wide-range application in terms of providing massage by virtue of positioning massage unit 29 at the bottom section of inner core 51. For example, massage unit 29 is capable of providing full-range neck massage to the user lying on top of the massage cushion. As another example, the massage cushion may be reversely positioned to provide massage to lower back areas of the human user. Further, the user may position the cushion in a location the user wishes in order to relieve minor aches and pains.

In addition, inner cover 61 need not be used in certain embodiments. Instead, outer cover 73 alone may directly receive the inner core 23 and directly receive attachment ring 117 of FIG. 7 and instead of attachment ring 97 of FIG. 6.

While particular embodiments of the invention have been shown, it will be understood that the invention is not limited thereto since modifications may be made by those skilled in the art, particularly in light of the foregoing teaching. It is therefore, the appended claims that define the true spirit and scope of the invention.

1. A decorative cushion, comprising:
an inner core having a dual foam structure, including:
(1) a first foam section formed as a unitary piece and having a first compressibility level; and
(2) a second foam section formed as a unitary piece and having a second compressibility level, said second foam section fixedly secured to said first foam section, said second foam section having an aperture and being disposed in a location spaced from the center of said inner core;
an electric massage unit configured to provide massage movement, said electric massage unit secured to said second foam section within said aperture;
a first cushion cover of a size for fully receiving said inner core, said first cushion cover including a closeable opening to permit manual insertion of said inner core within said first cushion cover; and
a second cushion cover of a size for fully receiving said inner core when covered with said first cushion cover, said second cushion cover including a closeable opening to permit manual insertion of said inner core covered with said first cushion cover.

2. A decorative cushion according to claim 1, and further including an ON/OFF switch electrically connected to said massage unit.

3. A decorative cushion according to claim 2, wherein said ON/OFF switch is securable with respect to said second cushion cover.

4. A decorative cushion according to claim 2 wherein said second cushion cover includes a power ON/OFF icon placed on the outer surface of said second cushion cover in a position to be aligned with said ON/OFF switch when said inner core is received by said first cushion cover.

5. A decorative cushion according to claim 4 wherein said ON/OFF switch is attachable to the underside surface of said first cushion cover relative to said power icon.

6. A decorative cushion according to claim 5 and further including an attachment mechanism configured to secure said ON/OFF switch with respect to the underside surface of said second cushion cover.

7. A decorative cushion according to claim 6 wherein said attachment mechanism connects said ON/Off switch to the underside surface of said first cushion cover by a loops-and-hooks attachment.

8. A decorative cushion according to claim 7 wherein said attachment mechanism includes a first component sewn to the underside surface of said first cushion cover and a second component mateable with said first component, said second component configured to hold said ON/OFF switch against the underside of said first cushion cover when said first and second components mate together.

9. A decorative cushion according to claim 4, wherein said power ON/OFF icon is located in a corner area of said second cushion cover.

10. A decorative cushion according to claim 2, and further comprising electrical wire connecting said ON/OFF switch to said massage unit.

11. A decorative cushion comprising:
an inner core having a dual foam structure, including:
(1) a first foam section formed as a unitary piece and having a first compressibility level; and
(2) a second foam section formed as a unitary piece and having a second compressibility level, said second foam section fixedly secured to said first foam section, said second foam section disposed in a location spaced from the center and in the lower portion of said inner core;
an electric massage unit configured to provide massage movement, said electrical massage unit secured to said second foam section;
a cushion over of a size for fully receiving said inner core, said first cushion cover including a closeable opening to permit manual insertion of said inner core within said cushion cover.

12. A decorative cushion according to claim 11, and further including an ON/OFF switch electrically connected to said massage unit.

13. A decorative cushion according to claim 12, wherein said cushion cover includes a power ON/OFF icon placed on the outer surface of said cushion cover in a position to be aligned with said ON/OFF switch when said inner core and said massage unit are received within said cushion cover.

14. A decorative cushion according to claim 12, wherein said ON/OFF switch is attachable to the underside surface of said cushion cover in a first attachment area.

15. A decorative cushion according to claim 12, wherein said ON/OFF switch has a structure configuration.

16. A decorative cushion according to claim 11, wherein said closeable opening of said cushion cover is located on the bottom of said cushion cover.

17. A decorative cushion according to claim 11, wherein said cushion cover includes two upper corners remotely from said opening, each one of said two upper corners being shaped in a pointy ear configuration.

18. A decorative cushion according to claim 11, wherein said first compressibility level of said first foam section provides a soft comfortable feeling to a user.
